(19) United States
(12) Patent Application Publication
(10) Pub. No.: US 2024/0025700 A1
(43) Pub. Date: Jan. 25, 2024

(54) METHOD AND SYSTEM FOR ESTIMATING ROPE SLIP IN AN ELEVATOR SYSTEM

(71) Applicant: KONE Corporation, Helsinki (FI)

(72) Inventors: Janne SALOMÄKI, Helsinki (FI); Mikko VILJANEN, Helsinki (FI); Lauri NEVAVUORI, Helsinki (FI)

(73) Assignee: KONE Corporation, Helsinki (FI)

(21) Appl. No.: 18/374,978

(22) Filed: Sep. 29, 2023

Related U.S. Application Data
(63) Continuation of application No. PCT/EP2021/058782, filed on Apr. 1, 2021.

(51) Int. Cl. B66B 5/00; B66B 5/02

(52) U.S. Cl. CPC B66B 5/0025; B66B 5/02

(57) ABSTRACT

A method for estimating rope slip in an elevator system, includes: during a normal operation mode of the elevator system, determining whether one or more predefined operational conditions are fulfilled; and if one or more of the predefined operational conditions are fulfilled, estimating rope slip in the elevator system during the normal operation mode of the elevator system.

The present invention relates to a method and a system for estimating rope slip in an elevator system, and, in particular, to a method and a system for estimating rope slip in an elevator system during normal operation mode of the elevator system.

An elevator is a device for the vertical movement of goods or people, typically within a building. A corresponding elevator system usually comprises an elevator car and a counterweight, wherein the elevator car and the counterweight are suspended in an elevator hoistway by suspension means. The suspension means, in particular elevator hoisting ropes, which can for example be steel ropes, coated ropes or belts, are arranged to run between the elevator car and the counterweight via a traction sheave of an elevator hoisting machine, wherein drive torque of the elevator car is generated by an electrical motor of the elevator hoisting machine and transferred to the elevator car and the counterweight via the elevator hoisting ropes, and wherein the torque generated by the electrical motor of the elevator hoisting machine is transferred to the hoisting ropes via friction between the hoisting ropes and the traction sheave.

Accordingly, the elevator car is lifted by the torque transferred to the hoisting ropes via friction between the hoisting ropes and the traction sheave. Therein, sufficient traction, respectively an adequate frictional force between the hoisting ropes and the traction sheave is required for accurate and safe elevator operation. However, over time the friction between the hoisting ropes and the traction sheave might decrease for example due to repeated use of the elevator system, having effect on wear of the suspension means, for example the wear of ropes, coated ropes or belts, or on wear of the traction sheave, or might decrease due to improperly performed rope greasing operation during maintenance. Also, change of elevator masses, for example a change in car decoration, etc., may have an effect of traction condition, wherefore the hoisting ropes do not smoothly respond to the generated drive torque anymore. This is especially critical when an emergency stop takes place in the proximity of the hoistway end. In particular, if the corresponding frictional force is too low, ropes may slip, resulting in a bad stopping accuracy or even in an insufficient braking in case of an emergency stop, respectively a hit against an end buffer.

Therefore, there is a need for determining respectively estimating the rope slip in the elevator system.

KR 20180130181 A describes a slip detection and control method, wherein a target moving distance of an elevator car is calculated by a speed controller associated with an encoder attached to the elevator, an actual moving distance of the elevator car is detected by a door zone checking device and transmitted to the speed controller, wherein such a door zone checking device is provided in each floor, wherein the speed controller is configured to compare and determine the target travel distance of the elevator car and the actual travel distance of the elevator car, and wherein it is recognized that a rope slip has occurred if a constant deviation between the target travel distance of the elevator car and the actual travel distance of the elevator car is detected.

According to one embodiment of the invention, a method for estimating rope slip in an elevator system is provided, wherein it is determined whether one or more predefined operational conditions are fulfilled during normal operation mode of the elevator system, and wherein, if one or more of the one or more predefined operational conditions are fulfilled, a rope slip in the elevator system is estimated during normal operation mode of the elevator system.

Therein, normal operation mode means that the elevator system is operated in a mode in which elevator passengers are served according to service requests, for example moved from a departure floor to a desired destination floor.

Further, the one or more operational conditions define operation conditions of the elevator system, and, in particular, operation conditions of the elevator system during which information about a possible rope slip can be reliably and unalteredly obtained, respectively the rope slip be accurately estimated.

That the rope slip is estimated during normal operation mode of the elevator system has the advantage that there is no need for corresponding manual tests performed during service visits, outside of the normal operation mode, respectively when the elevator system is out of operation. However, it is also possible to additionally perform manual tests, wherein the estimated rope slip gathered during the normal operation mode can be used as complementing and assistive data during these manual tests. The estimated rope slip can then for example be used to predict and correct problems before these problems cause more severe problems. Further, that the rope slip is only estimated if one or more of the one or more operational conditions are fulfilled respectively satisfied further has the advantage, that the rope slip is only estimated when the rope slip can reliably and unalteredly be estimated, whereby also computing resources and storage space can be saved. Therefore, an improved method for estimating the rope slip in an elevator system is provided.

Therein, the one or more operational conditions, respectively the operation conditions of the elevator system during which information about a possible rope slip can be reliably and unalteredly obtained, respectively the rope slip be accurately estimated can include that a travel length of an elevator car exceeds a predefined limit, that a current load of the elevator car is within predefined limits, and that the elevator car moves in a predefined direction. Alternatively, the aforementioned operational conditions can be determined and/or adjusted remotely, based on computational analysis for example in cloud analytics. It is also possible that the predefined limits are stored in the elevator control unit already during production, respectively when the elevator is delivered.

Therein, the predefined limit of the travel length, the predefined limits regarding the current load of the elevator car and the predefined direction can respectively be set by a producer of the elevator system, respectively during corresponding maintenance operation.

Further, the predefined operational conditions preferably define a situation in which the elevator car runs in a heavy direction. The elevator car for example runs in a heavy direction if the current load of the elevator car is between 0 and 10% of a nominal load of the elevator car and if the elevator car at the same time moves downwards, or if the current load of the elevator car is between 90 and 100% of the nominal load of the elevator car and if the elevator car at the same time moves upwards.

In one embodiment, the step of estimating the rope slip in the elevator system further comprises measuring, by a first sensor positioned at an elevator hoisting machine, a distance that a traction sheave of an elevator hoisting machine travels during a first time, measuring. by a second sensor positioned at the elevator car, a distance that the elevator car travels during the first time, determining a difference between the distance that the traction sheave of the elevator hoisting machine has travelled during the first time and the distance that the elevator car has travelled during the first time, and dividing the difference with the distance that the traction sheave of the elevator hoisting machine has travelled during the first time, whereby an estimated rope slip can be obtained.

Here, the first sensor and/or the second sensor can respectively be a motion sensor. A motion sensor is an electronic device that is designed to detect and measure movement of a corresponding object. Therein, sensors already included in a common elevator system can be used as motion sensors, for example sensors of an absolute position measurement system. Therefore, the rope slip can easily be estimated, without the need for extensive and costly rebuilding.

Therein, the distance that the traction sheave of the elevator hoisting machine travels during the first time and/or the distance that the elevator car travels during the first time can be measured during acceleration or deceleration of the elevator car. Thereby, reliable information about a degraded traction based on a rope slip can be obtained, as the driving torque reaches its optima during acceleration respectively deceleration of the elevator car.

Further, it is also possible to respectively estimate a separate value for the rope slip during acceleration and during deceleration, wherein a maximum value of these estimated values can then be recorded for monitoring, thereby achieving an accurate value of maximum slip.

In a further embodiment the one or more predefined conditions include that an end-to-end travel with an empty elevator car, respectively a round trip with a current load of the elevator car between 0 and 10% of the nominal load of the elevator car will take place. That the rope slip is determined when an end-to end travel with an empty elevator car will take place, and, in particular, during end-to-end travel with the empty elevator car, has the advantage that no sensors, respectively motion sensors positioned at the elevator car are required when estimating the rope slip.

During the end-to-end travel with the empty elevator car, the step of estimating the rope slip in the elevator system can further comprise measuring a distance that a traction sheave of an elevator hoisting machine travels while the elevator car moves between a top floor and a lowest floor and/or a distance that the traction sheave of the elevator hoisting machine travels while the elevator car moves between the lowest floor and the top floor, and estimating the rope slip based on the distance that the traction sheave of the elevator hoisting machine travels while the elevator car moves between the top floor and the lowest floor respectively the distance that the traction sheave of the elevator hoisting machine travels while the elevator car moves between the lowest floor and the top floor and a reference value of the elevator shaft distance.

The distance that the traction sheave of the elevator hoisting machine travels while the elevator car moves between the top floor and the lowest floor and/or the distance that the traction sheave of the elevator hoisting machine travels while the elevator car moves between the lowest floor and the top floor can for example be measured by a motor encoder, wherein such a motor encoder is usually included in common elevator systems. A motor encoder is a rotatory encoder mounted to an electric motor that provides closed loop feedback signals by tracking speed and/or position of a motor shaft.

Further, the reference value of the elevator shaft distance can be a distance between the lowest floor and the top floor if a distance that the traction sheave of the elevator hoisting machine travels while the elevator car moves between the top floor and the lowest floor is measured, or a distance between the top floor and the lowest floor if the distance that the traction sheave of the elevator hoisting machine travels while the elevator car moves between the lowest floor and the top floor is measured. The reference value of the elevator shaft can be older data, or data obtained during previous estimations of the rope slip, such that always data of a roundtrip is used to estimate the rope slip, thereby ensuring that no sensors, respectively motion sensors positioned at the elevator car are required for estimating the rope slip. However, the reference value of the elevator shaft can also be measured during a corresponding opposite movement of the elevator car, respectively a distance the traction sheave travels while the elevator car moves in the corresponding opposite direction.

According to a further embodiment of the invention, a method for monitoring safety conditions of an elevator system is provided, wherein the method comprises estimating a rope slip of the elevator system during normal operation mode of the elevator system using a method for estimating rope slip in an elevator system as described above, comparing the estimated rope slip to at least one threshold, and if the estimated rope slip exceeds the at least one threshold, initiating a safety-related action.

Thereby, a method for monitoring safety conditions of an elevator system is provided, that is based on an improved method for estimating the rope slip in the elevator system. In particular, that the rope slip is estimated during normal operation mode of the elevator system has the advantage that there is no need for corresponding manual tests performed during service visits, outside of the normal operation mode, respectively when the elevator system is out of operation. The estimated rope slip can then for example be used to predict and correct problems before these problems cause more severe problems. Further, that the rope slip is only estimated if one or more of the one or more operational conditions are fulfilled respectively satisfied further has the advantage, that the rope slip is only estimated when the rope slip can reliably and unalteredly be estimated, whereby also computing resources and storage space can be saved.

The safety-related action can for example include requesting maintenance of the elevator system or taking the elevator out of normal operation.

In some embodiments, maintenance of the elevator system may be requested directly if the estimated rope slip exceeds the at least one threshold, whereas maintenance of the elevator system may, however, also first be requested if a plurality of subsequently estimated rope slips have exceeded the at least one threshold or based on a rate of change of subsequently estimated rope slips.

Further, the estimated rope slip can be compared to a first threshold and a second threshold, wherein the second threshold is larger than the first threshold, wherein a first safety-related action is initiated if the estimated rope slip exceeds the first threshold, and wherein a second safety-related action is initiated if the estimated rope slip exceeds the second threshold. Therein, the first safety-related action can be requesting maintenance of the elevator system and the second safety-related action can be taking the elevator out of normal operation mode. Thereby, it can be ensured that the elevator is first taken out of normal operation when this is really necessary, wherein, however, at the same time bad stopping accuracy or even in an insufficient braking in case of an emergency stop can be avoided.

Further, after termination of the maintenance operation, new rope slip estimates may be determined, wherein the maintenance operation may be confirmed as successful if the newly estimated rope slip corresponds to an originally or previously estimated acceptable rope slip. Further, as long as the maintenance operation is carried out, the elevator car speed can be reduced compared to a nominal value for the elevator speed, wherein, after the maintenance operation has successfully completed, the elevator car speed is again set to the nominal value for the elevator speed.

The at least one threshold can be determined by estimating rope slips during a plurality of elevator runs, wherein the elevator runs are respectively carried out under different traction level conditions, and wherein the rope slips are respectively estimated using a method for estimating rope slip in an elevator system as described above, respectively performing an emergency stop of the elevator system during each of the plurality of elevator runs, wherein a corresponding distance the elevator car still travels after initiating the emergency stop is respectively detected, and performing a regression analysis based on the estimated rope slips and the detected distances the elevator car still travels after the emergency stop has been initiated.

Therein, traction level conditions mean conditions that can lead to different traction levels, for example different levels of wear of the traction sheave and or the hoisting ropes.

Further, a regression analysis is a set of statistical processes for estimating the relationships between a dependent value, respectively an output variable, and one or more independent variables, respectively predictors. Therein, the estimated rope slips can be used as predictors and the distances the elevator car still travels after the emergency stop has been initiated, respectively the stopping distances as output variables. In particular, regression analysis may be used for evaluating that a desired causality between the independent variables and the output variable has been achieved.

Therein, the at least one threshold for the rope slip can be determined based on the regression analysis in such a way, that it is fulfilled that a rope slip is allowed and does not exceed the at least one threshold if the corresponding distance the elevator car still travels after the emergency stop has been initiated does not exceed a maximum allowed emergency stopping distance of the elevator car, wherein the maximum allowed stopping distance is preferably determined in such a way, that elevator car movement can be stopped before a shaft end respectively an end buffer in an emergency braking situation is hit or that a maximum allowed buffer collision speed is not exceeded. Thereby, the at least one threshold can accurately be determined.

According to still a further embodiment of the invention, a system for estimating rope slip in an elevator system is provided, wherein the system comprises a first determining device which is configured to determine whether one or more predefined operational conditions are fulfilled during normal operation of the elevator system, and an estimating device which is configured to estimate rope slip of the elevator system during normal operation mode of the elevator system if one or more of the one or more predefined operation predefined operational conditions are fulfilled.

Thereby, an improved system for estimating the rope slip in an elevator system is provided. In particular, that the system is configured to estimate the rope slip during normal operation mode of the elevator system has the advantage that there is no need for corresponding manual tests performed during service visits, outside of the normal operation mode, respectively when the elevator system is out of operation. However, it is also possible to additionally perform manual tests, wherein the estimated rope slip gathered during the normal operation mode can be used as complementing and assistive data during these manual tests. The estimated rope slip can then for example be used to predict and correct problems before these problems cause more severe problems. Further, that the system is further configured to estimate the rope slip only if one or more of the one or more operational conditions are fulfilled respectively satisfied further has the advantage, that the rope slip is only estimated when the rope slip can reliably and unalteredly be estimated, whereby also computing resources and storage space can be saved.

The one or more operational conditions can again include that a travel length of an elevator car exceeds a predefined limit, that a current load of the elevator car is within predefined limits, and that an elevator car moves in a predefined direction. Alternatively, the aforementioned operational conditions can be determined and/or adjusted remotely, based on computational analysis for example in cloud analytics. It is also possible that the predefined limits are stored in the elevator control unit already during production, respectively when the elevator is delivered.

Therein, the predefined limit of the travel length, the predefined limits regarding the current load of the elevator car and the predefined direction can again respectively be set by a producer of the elevator system, respectively during corresponding maintenance operation.

Further, the predefined operational conditions preferably define a situation in which the elevator car runs in a heavy direction. The elevator car for example runs in a heavy direction if the current load of the elevator car is between 0 and 10% of a nominal load of the elevator car and if the elevator car at the same time moves downwards, or if the current load of the elevator car is between 90 and 100% of the nominal load of the elevator car and if the elevator car at the same time moves upwards.

Therein, the system can comprise a first sensor positioned at an elevator hoisting machine, wherein the first sensor is configured to measure a distance that a traction sheave of the elevator hoisting machine travels during a first time, and a second sensor positioned at an elevator car, wherein the second sensor is configured to measure a distance that the elevator car travels during the first time, and wherein the estimating device comprises a second determining device, which is configured to determine a difference between the distance that the traction sheave of the elevator hoisting machine has travelled during the first time and the distance that the elevator car has travelled during the first time, and a dividing device, which is configured to divide the difference with the distance that the traction sheave has travelled during the first time, to obtain the estimated rope slip.

Therein, sensors, in particular motion sensors already included in a common elevator system can be used, for example a sensor of an absolute position measurement system. Therefore, the rope slip can easily be estimated, without the need for extensive and costly rebuilding.

In particular, the second sensor can be a car pulley encoder or a car accelerometer. Such incremental sensors are cost-efficient and easily adaptable to various elevator systems. However, that the second sensor is a car pulley encoder or a car accelerometer should merely be understood as an example, and the second sensor can for example also be an overspeed governor encoder, a roller guide shoe encoder, a friction wheel encoder, or an acoustic sensor.

Further, the first sensor can be configured to measure the distance that a traction sheave of the elevator hoisting machine travels during the first-time during acceleration or deceleration of the elevator car, and/or the second sensor can be configured to measure the distance that the elevator car travels during the first-time during acceleration or deceleration of the elevator car. Thereby, the system can be configured to obtain reliable information about a degraded traction based on a rope slip, as the driving torque reaches its optima during acceleration respectively deceleration of the elevator car.

In a further embodiment, the one or more predefined conditions can include that an end-to-end travel with an empty elevator car will take place.

Therein, the system can further comprise a sensor, for example a motor encoder of the elevator hoisting machine, which is configured to measure a distance that a traction sheave of the elevator hoisting machine travels while the elevator car moves between a top floor and a lowest floor and/or a distance that the traction sheave of the elevator hoisting machine travels while the elevator car moves between the lowest floor and the top floor, and wherein the estimating device is configured to estimate the rope slip based on the distance that the traction sheave of the elevator hoisting machine travels while the elevator car moves between the top floor and the lowest floor respectively the distance that the traction sheave of the elevator hoisting machine travels while the elevator car moves between the lowest floor and the top floor and a reference value of the elevator shaft distance.

Thus, the rope slip can be estimated without the need of sensors, respectively motion sensors positioned at the elevator car for estimating the rope slip.

The reference value of the elevator shaft distance can again be a distance between the lowest floor and the top floor if a distance between the top floor and the lowest floor is measured, or a distance between the top floor and the lowest floor if a distance between the lowest floor and the top floor is measured. The reference value of the elevator shaft can be older data, in particular originally set values for example defined during setup of the elevator system, or data obtained during previous estimations of the rope slip, such that always data of a roundtrip is used to estimate the rope slip. However, the reference value of the elevator shaft can also be measured during a corresponding opposite movement of the elevator car, respectively a distance the traction sheave travels while the elevator car moves in the corresponding opposite direction.

According to still another embodiment of the invention, a system for monitoring safety conditions of an elevator system is provided, wherein the system comprises a system for estimating rope slip of the elevator system as described above, a comparing device, which is configured to compare the estimated rope slip to at least one threshold, and an initiating device, which is configured to initiate a safety related action if the estimated rope slip exceeds the at least one threshold.

Thereby, a system for monitoring safety conditions of an elevator system is provided that is based on an improved system for estimating the rope slip in the elevator system. In particular, that the system for estimating the rope slip in the elevator system is configured to estimate the rope slip during normal operation mode of the elevator system has the advantage that there is no need for corresponding manual tests performed during service visits, outside of the normal operation mode, respectively when the elevator system is out of operation. However, it is also possible to additionally perform manual tests, wherein the estimated rope slip gathered during the normal operation mode can be used as complementing and assistive data during these manual tests. The estimated rope slip can then for example be used to predict and correct problems before these problems cause more severe problems. Further, that the system for estimating the rope slip in the elevator system is further configured to estimate the rope slip only if one or more of the one or more operational conditions are fulfilled respectively satisfied further has the advantage, that the rope slip is only estimated when the rope slip can reliably and unalteredly be estimated, whereby also computing resources and storage space can be saved.

The safety-related action can again include requesting maintenance of the elevator system or taking the elevator out of normal operation.

Further, the comparing device can be configured to compare the estimated rope slip to a first threshold and to a second threshold, wherein the second threshold is larger than the first threshold, and wherein the initiating device can be configured to initiate a first safety-related action if the estimated rope slip exceeds the first threshold and to initiate a second safety-related action if the estimated rope slip exceeds the second threshold. Therein, the first safety-related action can be requesting maintenance of the elevator system and the second safety-related action can be taking the elevator out of normal operation. Thereby, it can be ensured that the elevator is first taken out of normal operation when this is really necessary, wherein, however, at the same time bad stopping accuracy or even in an insufficient braking in case of an emergency stop can be avoided.

The system can further comprise an actuator, for example a hoisting machine brake, which is configured to respectively perform an emergency stop of the elevator system during each of a plurality of elevator runs, a monitoring device which is configured to respectively detect a corresponding distance the elevator car still travels after initiating the emergency stop, and a third determining device which is configured to perform a regression analysis based on rope slips, wherein each of the rope slips is respectively detected during each of the plurality of elevator runs, and wherein the plurality of elevator runs are respectively carried out under different traction level conditions, and the detected distances the elevator car still travels after the emergency stop has been initiated to determine the at least one threshold. Thereby, the system is configured to accurately determine the at least one threshold.

According to still a further embodiment of the invention, an elevator system is provided, wherein the elevator system comprises an elevator car and an elevator traction system, wherein the elevator traction system comprises an elevator hoisting machine and hoisting ropes running between the elevator car and a counterweight via a traction sheave of the hoisting machine, and wherein the elevator system further comprises a system for monitoring safety conditions of the elevator system as described above.

Thereby, an elevator system is provided that comprises such an improved system for monitoring safety conditions of an elevator system respectively such an improved system for estimating the rope slip in the elevator system as described above.

In the following, the present invention will be described in more detail by the aid of some examples of its embodiments with reference to the attached drawings.

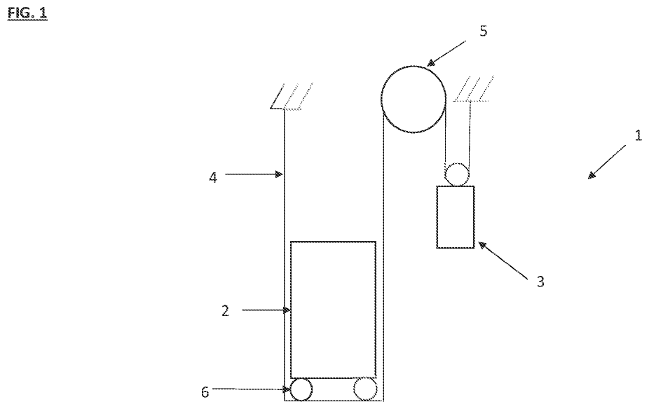

FIG. 1 illustrates an elevator system:

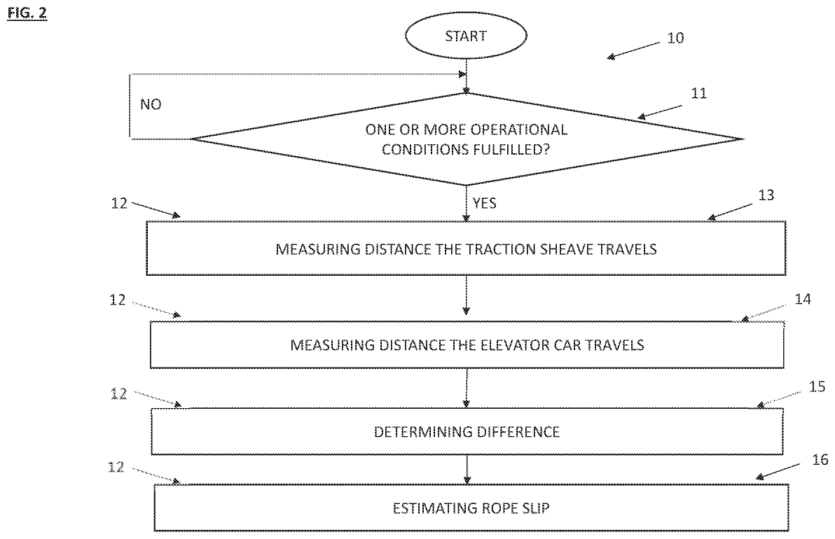

FIG. 2 illustrates a flowchart of a method for estimating rope slip in an elevator system according to a first embodiment of the invention;

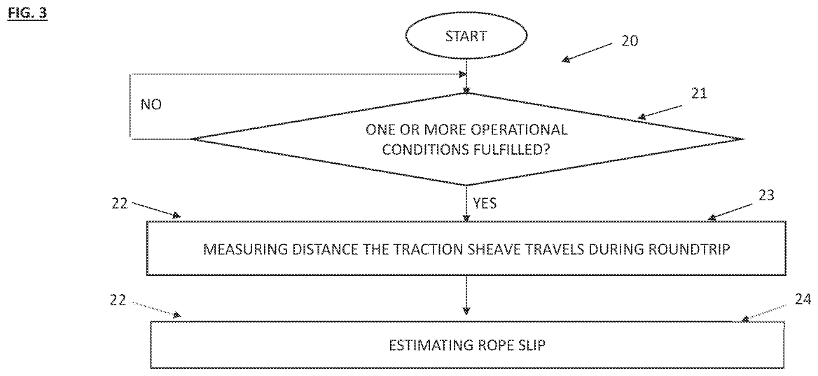

FIG. 3 illustrates a flowchart of a method for estimating rope slip in an elevator system according to a second embodiment of the invention;

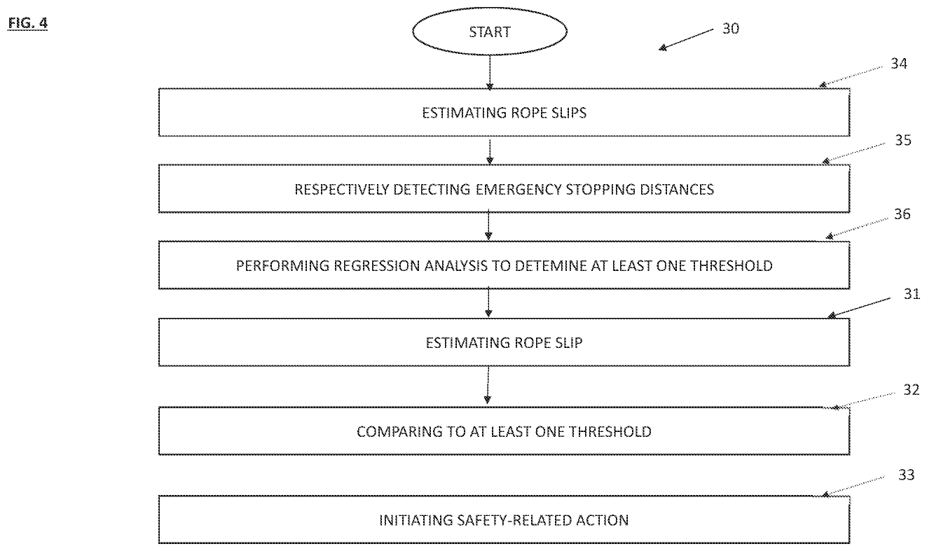

FIG. 4 illustrates a flowchart of a method for monitoring safety conditions of an elevator system according to embodiments of the invention;

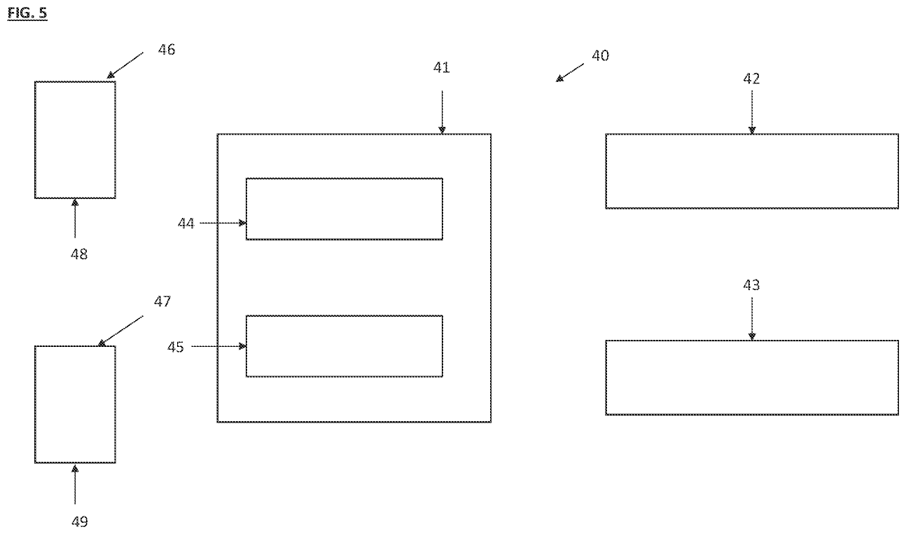

FIG. 5 illustrates an apparatus for monitoring safety conditions of an elevator system according to embodiments of the invention.

FIG. 1 illustrates an elevator system 1.

As shown in FIG. 1, the elevator system 1 comprises an elevator car 2 and a counterweight 3, wherein the elevator car 2 and the counterweight 3 are suspended in an elevator hoistway by suspension means, in particular by means of elevator hoisting ropes 4. The elevator hoisting ropes 4, which can for example be steel ropes, coated ropes or belts, are arranged to run between the elevator car 2 and the counterweight 3 via a traction sheave 5 of an elevator hoisting machine, wherein drive torque of the elevator car 2 is generated by an electrical motor of the elevator hoisting machine and transferred to the elevator car 2 and the counterweight 3 via the elevator hoisting ropes 4, and wherein the torque generated by the electrical motor of the elevator hoisting machine is transferred to the hoisting ropes 3 via friction between the hoisting ropes 3 and the traction sheave 5.

Accordingly, the elevator car 2 is lifted by the torque transferred to the hoisting ropes 4 via friction between the hoisting ropes 4 and the traction sheave 5. Therein, sufficient traction, respectively an adequate frictional force between the hoisting ropes 3 and the traction sheave 5 is required for accurate and safe elevator operation. However, over time the friction between the hoisting ropes 4 and the traction sheave 5 might decrease for example due to repeated use of the elevator system, having effect on wear of the suspension means, for example the wear of ropes, coated ropes or belts, or on wear of the traction sheave, or might decrease due to improperly performed rope greasing operation during maintenance. Also change of elevator masses, for example a change in car decoration, etc., may have effect on traction condition wherefore the hoisting ropes 4 do not smoothly respond to the generated drive torque anymore. This is especially critical when an emergency stop takes place in the proximity of the hoistway end. In particular, if the corresponding frictional force is too low, ropes may slip, resulting in a bad stopping accuracy or even in an insufficient braking in case of an emergency stop, respectively a hit against an end buffer.

Therefore, there is a need for determining respectively estimating the rope slip in the elevator system 1.

The shown elevator system 1 further comprises a condition monitoring device attached to the elevator car 2, wherein the condition monitoring device can be part of an absolute position measurement system, and wherein the condition monitoring device comprises a car pulley encoder 6.

FIG. 2 illustrates a flowchart of a method 10 for estimating rope slip in an elevator system according to a first embodiment of the invention.

As shown in FIG. 2, the method 10 comprises a step 11 of determining whether one or more predefined operational conditions are fulfilled during normal operation mode of the elevator system, wherein, if one or more of the predefined operational conditions are fulfilled, rope slip in the elevator system is estimated during normal operation mode of the elevator system in a step 12. On the other hand, if it is determined in step 11 that none of the one or more predetermined is currently fulfilled, step 11 is repeated.

That the rope slip is estimated during normal operation mode of the elevator system 1 has the advantage that there is no need for corresponding manual tests performed during service visits, outside of the normal operation mode, respectively when the elevator system 1 is out of operation. However, it is also possible to additionally perform manual tests, wherein the estimated rope slip gathered during the normal operation mode can be used as complementing and assistive data during these manual tests. The estimated rope slip can then for example be used to predict and correct problems before these problems cause more severe problems. Further, that the rope slip is only estimated if one or more of the one or more operational conditions are fulfilled respectively satisfied further has the advantage, that the rope slip is only estimated when the rope slip can reliably and unalteredly be estimated, whereby also computing resources and storage space can be saved. Therefore, an improved method 10 for estimating the rope slip in the elevator system is provided.

According to the first embodiment, the one or more operational conditions include that a travel length of an elevator car exceeds a predefined limit, that a current load of the elevator car is within predefined limits, and that the elevator car moves in a predefined direction.

Therein, the predefined limit of the travel length, the predefined limits regarding the current load of the elevator car and the predefined direction have respectively been set by a producer of the elevator system, respectively during corresponding maintenance operation.

According to the first embodiment, the predefined operational conditions further define a situation in which the elevator car runs in a heavy direction. The elevator car for example runs in a heavy direction if the current load of the elevator car is between 0 and 10% of a nominal load of the elevator car and if the elevator car at the same time moves downwards, or if the current load of the elevator car is between 90 and 100% of the nominal load of the elevator car and if the elevator car at the same time moves upwards.

Further, in the method 10, the rope slip is estimated on a remote system, wherein the remote system can include a host-server located at a corresponding maintenance provider or a cloud system, wherein the corresponding data is transmitted from the elevator system to the remote server via a communication link, wherein the communication link can be a wireless communication link or a wired communication link. However, the rope slip can also be estimated on the elevator site, respectively in an electronic control unit of the elevator system, provided that the electronic control unit has sufficient processing capabilities.

Further, as shown in FIG. 1, the step 12 of estimating the rope slip in the elevator system during normal operation mode of the elevator system further comprises a step 13 of measuring, by a first sensor positioned at an elevator hoisting machine, a distance that a traction sheave of an elevator hoisting machine travels during a first time, a step 14 of measuring, by a second sensor positioned at the elevator car, a distance that the elevator car travels during the first time, a step 15 of determining a difference between the distance that the traction sheave of the elevator hoisting machine has travelled during the first time and the distance that the elevator car has travelled during the first time, and a step 16 of dividing the difference with the distance that the traction sheave of the elevator hoisting machine has travelled during the first time, to obtain an estimated rope slip.

In particular, according to the first embodiment, the rope slip is estimated based on the following formula:

$${s}_{ST} = \frac{\vert {d}_{tot , m} - {d}_{tot , c} \vert}{{d}_{tot , m}} , \qquad ( 1 )$$

Wherein s_{ST} is the estimated rope slip, d_{tot,m} is the distance that the traction sheave of the elevator hoisting machine travels during the first time, and wherein d_{tot,c} is the distance that the elevator car travels during the first time.

Therein, according to the first embodiment, the rope slip is only estimated if the distance that the traction sheave of the elevator hoisting machine travels during the first time is at least 2 m.

Further, formula (1) does not separate the actual slip and creeping. However, the distance that the elevator car travels during the first time can for example be measured by a sensor respectively condition monitoring device of an absolute position measurement system, wherein sensor scaling can be executed during setup run, and wherein, however, there should not be creeping during the setup run.

Furthermore, the distance that the traction sheave of the elevator hoisting machine travels during the first time and/or the distance that the elevator car travels during the first time can also be measured during acceleration or deceleration of the elevator car, as the slip during acceleration and deceleration better reflects the average slip during the whole run.

Therein, a travel distance Δd can be determined,

wherein Δd=dₘ−d_{c}, (2)

wherein dₘ is the distance that the traction sheave has travelled during the first time, d_{c} is the distance that the elevator car has travelled during the first time, and wherein dₘ as well as d_{c} are signed in such a way, that dₘ and d_{c} are signed positive when the elevator car moves upward.

The travel distance can then be filtered to for example filter out measurement noise, wherein, for example, a 4-order average filter can be used.

The average rope slip during acceleration s_{acc} can then be estimated based on

$${s}_{acc} = \vert \frac{Δ {d}_{fiit , accend}}{{d}_{m , accend}} \vert , \qquad ( 3 )$$

wherein Δd_{filt,accend} is the filtered travel distance at the end of the acceleration and d_{m,accend} is the distance that the traction sheave has traveled at the end of the acceleration.

On the other hand, the average rope slip during deceleration s_{dec} can be estimated based on

$${s}_{dec} = \vert \frac{Δ {d}_{filt , end} - Δ {d}_{filt , decstart}}{{d}_{m , end} - {d}_{m , decstart}} \vert , \qquad ( 4 )$$

wherein Δd_{filt,end} is the filtered travel distance at the end of the corresponding elevator run. Δd_{filt,decstart} is the filtered travel distance at the start of the deceleration, d_{m,decstart} is the distance the traction sheave has traveled during the corresponding elevator run at the start of the deceleration, and wherein d_{m,end} is the distance the traction sheave has travelled at the end of the corresponding elevator run.

Therein, it is also possible to respectively estimate a separate value for the rope slip during acceleration and during deceleration, wherein a maximum value of these estimated values can then be recorded for monitoring, thereby achieving an accurate value of maximum slip.

Furthermore, the estimated rope slip may then be stored for further processing, wherein the estimated rope slip can for example be stored in a memory of a host server of a corresponding maintenance provider, or in a memory of an electronic control unit of the elevator system. The stored estimated rope slip can later on be updated based on new estimations.

FIG. 2 illustrates a flowchart of a method 20 for estimating rope slip in an elevator system according to a second embodiment of the invention.

As shown in FIG. 2, the method 20 again comprises a step 21 of determining whether one or more predefined operational conditions are fulfilled during normal operation mode of the elevator system, wherein, if one or more of the predefined operational conditions are fulfilled, rope slip in the elevator system is estimated during normal operation mode of the elevator system in a step 22. On the other hand, if it is determined in step 21 that none of the one or more predetermined is currently fulfilled, step 21 is repeated.

The difference between the method 10 according to the first embodiment as shown in FIG. 1 and the method 20 according to the second embodiment as shown in FIG. 2 is that, according to the second embodiment, the one or more predefined conditions include that an end-to-end travel with an empty elevator car will take place, wherein the step 22 of estimating the rope slip in the elevator system further comprises the step 23 of measuring a distance that a traction sheave of an elevator hoisting machine travels while the elevator car moves between a top floor and a lowest floor and/or a distance that the traction sheave of the elevator hoisting machine travels while the elevator car moves between the lowest floor and the top floor, and a step 24 of estimating the rope slip based on the distance that the traction sheave of the elevator hoisting machine travels while the elevator car moves between the top floor and the lowest floor respectively the distance that the traction sheave of the elevator hoisting machine travels while the elevator car moves between the lowest floor and the top floor and a reference value of the elevator shaft distance.

Therein, the method 20 according to the second embodiment has the advantage that no sensors, respectively motion sensors positioned at the elevator car are required for estimating the rope slip.

Further, the reference value of the elevator shaft distance can be a distance between the lowest floor and the top floor if a distance between the top floor and the lowest floor is measured, or a distance between the top floor and the lowest floor if a distance between the lowest floor and the top floor is measured. The reference value of the elevator shaft distance can be older data, or data obtained during previous estimations of the rope slip, such that always data of a roundtrip is used to estimate the rope slip, thereby ensuring that no sensors, respectively motion sensors positioned at the elevator car are required for estimating the rope slip. However, the reference value of the elevator shaft can also be measured during a corresponding opposite movement of the elevator car, respectively a distance the traction sheave travels while the elevator car moves in the corresponding opposite direction.

For example, if the reference value of the elevator shaft is measured during a corresponding opposite movement of the elevator car, the rop slipe sᵣₜ can be estimated based on the following formula:

$${s}_{rt} = \frac{{d}_{down} + {d}_{up}}{2 {D}_{s}} , \qquad ( 5 )$$

wherein d_{down} is the distance the traction sheave travels while the empty elevator car moves between the lowest floor and the top floor, dᵤₚ is the distance the traction sheave travels while the empty elevator car moves between the top floor and the lowest floor, wherein d_{down} and dᵤₚ are respectively signed in such a way, that a value for d_{down} is signed negative when the elevator car moves downwards and a value for duo is signed positive when the elevator car moves upwards, and wherein Dₛ is a corresponding length of the elevator hoistway, wherein the corresponding length of the elevator hoistway can be measured during setup of the elevator system.

Therein, the elevator runs during which d_{down} and dᵤₚ are measured do not necessarily have to be consecutive runs, and one of the measured distances can also be stored until the other distance is measured during a subsequent correspondingly acceptable elevator run.

FIG. 4 illustrates a flowchart of a method 30 for monitoring safety conditions of an elevator system according to embodiments of the invention.

In particular, FIG. 4 illustrates a method 30 for monitoring safety conditions of an elevator system, which comprises a step 31 of estimating a rope slip of the elevator system during normal operation mode of the elevator system, a step 32 of comparing the estimated rope slip to at least one threshold, and a step 33 of initiating a safety-related action, if the estimated rope slip exceeds the at least one threshold.

According to the embodiments of FIG. 4, the safety-related action includes requesting maintenance of the elevator system, wherein after termination of the maintenance operation, new rope slip estimates may be determined, wherein the maintenance operation may be confirmed as successful if the newly estimated rope slip corresponds to an originally or previously estimated acceptable rope slip. Further, as long as the maintenance operation is carried out, the elevator car speed can be reduced compared to a nominal value for the elevator speed, wherein, after the maintenance operation has successfully completed, the elevator car speed is again set to the nominal value for the elevator speed.

According to the embodiments of FIG. 4, the estimated rope slip is further compared to a first threshold and a second threshold, wherein the second threshold is larger than the first threshold, wherein a first safety-related action is initiated if the estimated rope slip exceeds the first threshold, and wherein a second safety-related action is initiated if the estimated rope slip exceeds the second threshold. Therein, the first safety-related action includes requesting maintenance of the elevator system and the second safety-related action is taking the elevator out of normal operation.

The method shown in FIG. 4 further includes the determination of the at least one threshold, wherein the determination of the at least one threshold at least one threshold comprises a step 34 of estimating rope slips during a plurality of elevator runs, wherein the elevator runs are respectively carried out under different traction level conditions, and wherein the rope slips are respectively estimated using a method for estimating rope slip in an elevator system as described above, a step 35 of respectively performing an emergency stop of the elevator system during each of the plurality of elevator runs, wherein a corresponding distance the elevator car still travels after initiating the emergency stop is respectively detected, and a step 36 of performing a regression analysis based on the estimated rope slips and the detected distances the elevator car still travels after the emergency stop has been initiated.

Therein, the at least one threshold for the rope slip can be determined based on the regression analysis in such a way, that it is fulfilled that a rope slip is allowed and does not exceed the at least one threshold if the corresponding distance the elevator car still travels after the emergency stop has been initiated does not exceed a maximum allowed emergency stopping distance of the elevator car, wherein the maximum allowed stopping distance is preferably determined in such a way, that elevator car movement can be stopped before a shaft end respectively an end buffer in an emergency braking situation is hit, or that the maximum allowed buffer collision speed is not exceeded. Thereby, the at least one threshold can accurately be determined.

FIG. 5 illustrates a system 40 for monitoring safety conditions of an elevator system according to embodiments of the invention.

Therein, the shown system 40 for monitoring safety conditions of an elevator system, comprises a system 41 for estimating rope slip of the elevator system, a comparing device 42, which is configured to compare the estimated rope slip to at least one threshold, and an initiating device 43, which is configured to initiate a safety related action if the estimated rope slip exceeds the at least one threshold.

Therein, the comparing device can include a processing device and a memory in which code is stored, wherein the code is executable by the processing device and comprises code to compare the estimated rope slip to at least one threshold. Further, the initiating device can include a transmitter in order to forward a corresponding request to a maintenance provider.

The shown system 41 for estimating rope slip in an elevator system further comprises a first determining device 44 which is configured to determine whether one or more predefined operational conditions are fulfilled during normal operation of the elevator system, and an estimating device 45 which is configured to estimate rope slip of the elevator system during normal operation mode of the elevator system if one or more of the one or more predefined operation predefined operational conditions are fulfilled.

Therein, the determining device can include a monitoring device to monitor an operational condition of the elevator system, a processing device and a memory in which code is stored, wherein the code is executable by the processing device and comprises code to determine whether one or more predefined operational conditions are fulfilled. Further, the estimating device can comprise a processing device and a memory in which code is stored, wherein the code is executable by the processing device and comprises code to estimate the rope slip based on of the corresponding methods as described above with respect to FIG. 2 and FIG. 3.

Similarly, also the system 40 can comprise an electronic control unit with a processing device and a memory in which code is stored, wherein the code is executable by the processing device and comprises code to for example determine at least one threshold as described above with respect to FIG. 4.

There are further shown a first sensor 46 positioned at an elevator hoisting machine and configured to measure a distance a traction sheave of the elevator hoisting machine travels, and a second sensor 47 positioned at an elevator car and configured to measure a distance the elevator car travels.

Therein, according to the embodiments of FIG. 5, the first sensor 46 is a motor encoder 48 coupled to a motor of the elevator hoisting machine and the second sensor 47 is a car pulley encoder 49.

It is obvious to the skilled person that, along with the technical progress, the basic idea of the invention can be implemented in many ways. The invention and its embodiments are thus not limited to the examples described above but they may vary within the contents of patent claims and their legal equivalents.

### LIST OF REFERENCE SIGNS

1 elevator system
2 elevator car
3 counterweight
4 elevator hoisting ropes
5 traction sheave
6 car pulley encoder
10 method
11 step
12 step
13 step
14 step
15 step
16 step
20 method
21 step
22 step
23 step
24 step
30 method
31 step
32 step
33 step
34 step
35 step
36 step
40 system
41 system
42 comparing device
43 initiating device
44 first determining device
45 estimating device
46 first sensor
47 second sensor
48 motor encoder
49 car pulley encoder

1. A method for estimating rope slip in an elevator system, wherein the method comprises the steps of:
during a normal operation mode of the elevator system, determining whether one or more predefined operational conditions are fulfilled; and
if one or more of the predefined operational conditions are fulfilled, estimating rope slip in the elevator system during the normal operation mode of the elevator system.

2. The method according to claim 1, wherein the one or more predefined conditions include that a travel length of an elevator car exceeds a predefined limit, that a current load of the elevator car is within predefined limits, and that the elevator car moves in a predefined direction.

3. The method according to claim 2, wherein the step of estimating the rope slip in the elevator system further comprises the steps of:
measuring, by a first sensor positioned at an elevator hoisting machine, a distance that a traction sheave of the elevator hoisting machine travels during a first time;
measuring, by a second sensor positioned at the elevator car, a distance that the elevator car travels during the first time;
determining a difference between the distance that the traction sheave of the elevator hoisting machine has travelled during the first time and the distance that the elevator car has travelled during the first time; and
dividing the difference with the distance that the traction sheave of the elevator hoisting machine has travelled during the first time, to obtain an estimated rope slip.

4. The method according to claim 4, wherein the distance that the traction sheave of the elevator hoisting machine travels during the first time and/or the distance that the elevator car travels during the first time are measured during acceleration or deceleration of the elevator car.

5. The method according to claim 1, wherein the one or more predefined conditions include that an end-to-end travel with an empty elevator car will take place.

6. The method according to claim 5, wherein the step of estimating the rope slip in the elevator system further comprises the steps of:
measuring a distance a traction sheave of an elevator hoisting machine travels while the elevator car moves between a top floor and a lowest floor and/or a distance the traction sheave of the elevator hoisting machine travels while the elevator car moves between the lowest floor and a top floor; and
estimating the rope slip based on the distance the traction sheave travels while the elevator car moves between the top floor and the lowest floor respectively the distance the traction sheave travels while the elevator car moves between the lowest floor and the top floor and a reference value of the elevator shaft distance.

7. A method for monitoring safety conditions of an elevator system, wherein the method comprises the steps of:
during a normal operation mode of the elevator system, estimating a rope slip of the elevator system using the method for estimating rope slip in an elevator system according to claim 1;
comparing the estimated rope slip to at least one threshold; and
if the estimated rope slip exceeds the at least one threshold, initiating a safety-related action.

8. The method according to claim 7, wherein the safety-related action includes requesting maintenance of the elevator system or taking the elevator out of normal operation.

9. The method according to claim 7, wherein the estimated rope slip is compared to a first threshold and a second threshold, wherein the second threshold is larger than the first threshold, wherein a first safety-related action is initiated if the estimated rope slip exceeds the first threshold, and wherein a second safety-related action is initiated if the estimated rope slip exceeds the second threshold.

10. The method according to claim 7, wherein the at least one threshold is determined by estimating rope slips during a plurality of elevator runs, wherein the plurality of elevator runs are respectively carried out under different traction level conditions, and wherein the rope slips are respectively estimated using said method for estimating rope slip in an elevator system, respectively performing an emergency stop of the elevator system during each of the plurality of elevator runs, wherein a corresponding distance the elevator car still travels after initiating the emergency stop is respectively detected, and performing a regression analysis based on the estimated rope slips and the detected distances the elevator car still travels after the emergency stop has been initiated.

11. A system for estimating rope slip in an elevator system, wherein the system comprises:
a first determining device configured to determine whether one or more predefined operational conditions are fulfilled during a normal operation of the elevator system; and
an estimating device configured to estimate rope slip of the elevator system during the normal operation mode of the elevator system if one or more of the one or more predefined operational conditions are fulfilled.

12. The system according to claim 11, wherein the one or more predefined operational conditions include that a travel length of an elevator car exceeds a predefined limit, that a current load of the elevator car is within predefined limits, and that the elevator car moves in a predefined direction.

13. The system according to claim 11, wherein the system comprises a first sensor positioned at an elevator hoisting machine, wherein the first sensor is configured to measure a distance that a traction sheave of the elevator hoisting machine travels during a first time, and a second sensor positioned at the elevator car, wherein the second sensor is configured to measure a distance that the elevator car travels during the first time, and wherein the estimating device comprises a second determining device, configured to determine a difference between the distance that the traction sheave of the elevator hoisting machine has travelled during the first time and the distance that the elevator car has travelled during the first time, and a dividing device, configured to divide the difference with the distance that the traction sheave has travelled during the first time, to obtain the estimated rope slip.

14. The system according to claim 13, wherein the second sensor is a car pulley encoder or a car accelerometer.

15. The system according to claim 13, wherein the first sensor is configured to measure the distance that the traction sheave of the elevator hoisting machine travels during the first-time during acceleration or deceleration of the elevator car, and/or wherein the second sensor is configured to measure the distance that the elevator car travels during the first-time during acceleration or deceleration of the elevator car.

16. The system according to claim 11, wherein the one or more predefined conditions include that an end-to-end travel with an empty elevator car will take place.

17. The system according to claim 16, wherein the system further comprises a sensor configured to measure a distance a traction sheave of an elevator hoisting machine travels while the elevator car moves between a top floor and a lowest floor and/or a distance the traction sheave of the elevator hoisting machine travels while the elevator car moves between the lowest floor and the top floor, and wherein the estimating device is configured to estimate the rope slip based on the distance the traction sheave of the elevator hoisting machine travels while the elevator car moves between the top floor and the lowest floor respectively the distance the traction sheave of the elevator hoisting machine travels while the elevator car moves between the lowest floor and the top floor and a reference value of the elevator shaft distance.

18. A system for monitoring safety conditions of an elevator system, wherein the system comprises;
the system for estimating rope slip of the elevator system according to claim 11;
a comparing device configured to compare the estimated rope slip to at least one threshold; and
an initiating device configured to initiate a safety related action if the estimated rope slip exceeds the at least one threshold.

19. The system according to claim 18, wherein the safety-related action includes requesting maintenance of the elevator system or taking the elevator out of normal operation.

20. The system according to claim 18, wherein the comparing device is configured to compare the estimated rope slip to a first threshold and to a second threshold, wherein the second threshold is larger than the first threshold, and wherein the initiating device is configured to initiate a first safety-related action if the estimated rope slip exceeds the first threshold and to initiate a second safety-related action if the estimated rope slip exceeds the second threshold.

21. The system according to claim 18, wherein the system further comprises an actuator configured to respectively perform an emergency stop of the elevator system during each of a plurality of elevator runs, a monitoring device configured to respectively detect a corresponding distance the elevator car still travels after initiating the emergency stop, and a third determining device configured to perform a regression analysis based on rope slips, wherein each of the rope slips is respectively detected during each of the plurality of elevator runs, wherein the plurality of elevator runs are respectively carried out under different traction level conditions, and the detected distances the elevator car still travels after the emergency stop has been initiated to determine the at least one threshold.

22. An elevator system, wherein the elevator system comprises:
an elevator car;
an elevator traction system, wherein the elevator traction system comprises an elevator hoisting machine and hoisting ropes running between the elevator car and a counterweight via a traction sheave of the hoisting machine; and
the system for monitoring safety conditions of the elevator system according to claim 18.
